(19) United States
(12) Patent Application Publication
(10) Pub. No.: US 2023/0147906 A1
(43) Pub. Date: May 11, 2023

(54) CHOPPED CARBON FIBER BUNDLE AND METHOD FOR PRODUCING CHOPPED CARBON FIBER BUNDLE

(71) Applicant: Mitsubishi Chemical Corporation, Tokyo (JP)

(72) Inventor: Kenji KANETA, Tokyo (JP)

(73) Assignee: Mitsubishi Chemical Corporation, Tokyo (JP)

(21) Appl. No.: 18/148,186

(22) Filed: Dec. 29, 2022

Related U.S. Application Data
(63) Continuation of application No. PCT/JP2021/025108, filed on Jul. 2, 2021.

(30) Foreign Application Priority Data
Jul. 3, 2020 (JP) 2020-115761

(51) Int. Cl. C08K 7/06; C08K 3/04; C08L 63/00

(52) U.S. Cl. CPC C08K 7/06; C08K 3/04; C08L 63/00

(57) ABSTRACT

A chopped carbon fiber bundle comprising carbon fibers and a sizing agent, the sizing agent including a compound having a maleimide group, the compound having a maleimide group being liquid at 25° C. A method for producing a chopped carbon fiber bundle, the method comprising a step of applying an aqueous dispersion of a secondary sizing agent including a compound having a maleimide group to a long-length carbon fiber bundle including a primary sizing agent deposited thereon, in order to prepare a long-length carbon fiber bundle further including the aqueous dispersion of the secondary sizing agent, and a step of cutting the long-length carbon fiber bundle including the aqueous dispersion of the secondary sizing agent. A chopped carbon fiber bundle that has improved. heat resistance and. feedabli and that is capable of beng produced with high productivity is provided.

### CROSS REFERENCE TO RELATED APPLICATIONS

The present application is a continuation of PCT/JP2021/025108, filed on Jul. 2, 2021, which is based on Japanese Patent Application No. 2020-115761 filed on Jul. 3, 2020, which is incorporated herein by reference in its entirety.

### TECHNICAL FIELD

The present invention relates to a chopped carbon fiber bundle and a method for producing the chopped carbon fiber bundle.

### BACKGROUND ART

Adding a fibrous filler, such as carbon fibers, to a thermoplastic resin is a commonly known approach to increasing the mechanical strength of a thermoplastic resin. An example of the method for adding carbon fibers to a thermoplastic resin is to melt-knead chopped carbon fiber bundles and a thermoplastic resin with an extruder. The above chopped carbon fiber bundles are produced by applying a sizing agent to a long-length carbon fiber bundle and subsequently cutting the long-length carbon fiber bundle into pieces.

Thermoplastic resins excellent in terms of mechanical strength and heat resistance (super engineering plastics) have been being used recently. The temperature at which a super engineering plastic is melt-kneaded with an extruder, that is, the melt-kneading temperature of the super engineering plastic, is about 300° C. to 400° C., which is higher than the melt-kneading temperature of general-purpose thermoplastic resins. When chopped carbon fiber bundles are melt-kneaded with a super engineering plastic at about 300° C. to 400° C., the sizing agent deposited on the carbon fiber bundles may become pyrolyzed to produce a gas inside the extruder.

The gas produced by the pyrolysis of the sizing agent inhibits extrusion molding from being performed in a consistent manner and consequently degrades the mechanical properties of the resulting molded product. Therefore, the sizing agent deposited on chopped carbon fiber bundles is required to have the resistance (heat resistance) with which the amount of gas produced by pyrolysis can be reduced.

The sizing agent is used to prevent a chopped carbon fiber bundle from disintegrating into carbon fiber filaments. If the binding force of the carbon fiber bundle which is produced by the sizing agent is weak and the chopped carbon fiber bundle becomes disintegrated, the detached carbon fiber filaments may cause bridging of the chopped carbon fiber bundles. Bridging may make it difficult to feed the chopped carbon fiber bundles from a hopper to a feeder and from the feeder to an extruder at a constant rate. Bridging may also cause intertwined carbon fiber filaments to block the transportation performed by the screw of the extruder. Therefore, chopped carbon fiber bundles are also required to have a high binding property produced by a sizing agent and to be readily fed to an extruder (feed property).

Under the circumstance, attempts have been made to produce a chopped carbon fiber bundle that is excellent in terms of both heat resistance and feed property.

In PTL 1, a technique that relates to a sizing agent excellent in terms of heat resistance, which includes an epoxy resin and an aromatic polyimide resin having a functional group attached to the side chain, is described.

In PTL 2, a technique for producing chopped strands, in which chopped strands are heated within a specific temperature range in order to reduce the amount of decomposition gas and free fibers produced during molding, is described.

PTL 1: JP2014-125688A

PTL 2: JP1998-1877A (JP-H10-1877A)

An object of the present invention is to produce a chopped carbon fiber bundle excellent in terms of both heat resistance and the mechanical properties of a molded product with high productivity.

### SUMMARY OF INVENTION

The inventor of the present invention found that the above object can be achieved when the chopped carbon fiber bundle includes a specific compound having a maleimide group.

The present invention includes the following aspects.

### Advantageous Effects of Invention

[1] A chopped carbon fiber bundle comprising carbon fibers and a sizing agent, the sizing agent including a compound having a maleimide group, the compound having a maleimide group being liquid at 25° C.
[2] A chopped carbon fiber bundle comprising carbon fibers and a sizing agent, the sizing agent including a compound having a maleimide group, the compound having a maleimide group having an aliphatic hydrocarbon group having 2 or more carbon atoms.
[3] The chopped carbon fiber bundle according to [1] or [2], wherein a viscosity of the compound having a maleimide group at 25° C. is 100000 mPa·s or less.
[4] The chopped carbon fiber bundle according to any one of [1] to [3], wherein the compound having a maleimide group is a compound represented by Formula m1 or m3 below,

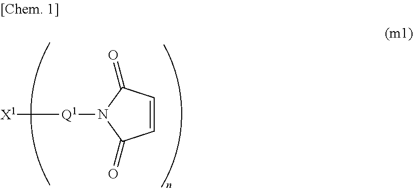

in Formula (m1), X¹ represents a substituted or unsubstituted alicyclic hydrocarbon group having 5 to 8 carbon atoms, Q¹ represents an aliphatic hydrocarbon group having 4 to 50 carbon atoms, and n represents 1 or 2, and

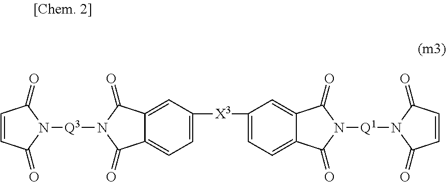

in Formula (m3), Q³ and Q⁴ each independently represent an aliphatic hydrocarbon group (including alicyclic hydrocarbon group) having 6 to 100 carbon atoms, and X³ represents an alkylene group having 2 to 20 carbon atoms, a cycloalkylene group having 5 to 8 carbon atoms, a polyoxyalkylene group represented by —(C_{q}H_{2q}O)ₜ—(CᵣH₂ᵣO)ᵤ—CₛH₂ₛ— (where q, r, and s each independently represent an integer of 2 to 6, t represents 0 or 1, and u represents an integer of 1 to 30), a divalent aromatic group having 6 to 12 carbon atoms, a group represented by —O—C₆H₄-Q⁶-C₆H₄—O— where Q⁶ represents —CH₂—, —C(CH₃)₂—, —CO—, —O—, —S—, or —SO₂—), or a group formed as a result of 1 to 3 hydrogen atoms included in any of the above groups being replaced with a hydroxyl group.
[5] The chopped carbon fiber bundle according to any one of [1] to [4], wherein the chopped carbon fiber bundle has a bulk density of 200 g/L or more.
[6] The chopped carbon fiber bundle according to any one of [1] to [5], wherein the chopped carbon fiber bundle has a bulk density of 600 g/L or less.
[7] The chopped carbon fiber bundle according to any one of [1] to [6], wherein the compound having a maleimide group has a plurality of maleimide groups per molecule.
[8] The chopped carbon fiber bundle according to any one of [1] to [7], wherein the compound having a maleimide group has an aliphatic portion having 5 or more carbon atoms.
[9] The chopped carbon fiber bundle according to any one of [1] to [8], wherein the sizing agent further includes a compound having an epoxy group, the compound not having a maleimide group.
[10] A chopped carbon fiber bundle comprising carbon fibers and a sizing agent, the sizing agent including a compound having a maleimide group, wherein a viscosity of the compound having a maleimide group at 25° C. is 100000 mPa·s or less.
[11] The chopped carbon fiber bundle according to [10], wherein the chopped carbon fiber bundle has a bulk density of 200 g/L or more.
[12] The chopped carbon fiber bundle according to [10] or [11], wherein the compound having a maleimide group has an aliphatic portion having 5 or more carbon atoms.
[13] The chopped carbon fiber bundle according to any one of [10] to [12], wherein the sizing agent further includes a compound having an epoxy group, the compound not having a maleimide group.
[14] A chopped carbon fiber bundle comprising carbon fibers and a compound having a maleimide group, wherein a content of the compound having a maleimide group in the chopped carbon fiber bundle is 10% by mass or less, and the compound having a maleimide group has an aliphatic hydrocarbon group having 2 or more carbon atoms.
[15] The chopped carbon fiber bundle according to [14], wherein the chopped carbon fiber bundle has a bulk density of 200 g/L or more.
[16] The chopped carbon fiber bundle according to [14] or [15], wherein the compound having a maleimide group has an aliphatic portion having 5 or more carbon atoms.
[17] The chopped carbon fiber bundle according to any one of [14] to [16], wherein the sizing agent further includes a compound having an epoxy group, the compound not having a maleimide group.
[18] A pellet comprising the chopped carbon fiber bundle according to any one of [1] to [17] and a matrix resin.
[19] A molded article comprising the pellet according to [18].
[20] A method for producing a chopped carbon fiber bundle, the method comprising a step of applying an aqueous dispersion of a secondary sizing agent including a compound having a maleimide group to a long-length carbon fiber bundle including a primary sizing agent deposited thereon, in order to prepare a long-length carbon fiber bundle further including the aqueous dispersion of the secondary sizing agent, and a step of cutting the long-length carbon fiber bundle including the aqueous dispersion of the secondary sizing agent.
[21] A method for producing a chopped carbon fiber bundle, the method comprising a step of applying an aqueous dispersion of a sizing agent including a compound having a maleimide group, the compound being liquid at 25° C., to a long-length carbon fiber bundle in order to prepare a long-length carbon fiber bundle including the sizing agent deposited thereon, and a step of cutting the long-length carbon fiber bundle including the sizing agent deposited thereon.
[22] A sizing agent comprising a compound having a maleimide group, the compound being liquid at 25° C., and an epoxy resin.

The chopped carbon fiber bundle according to the present invention is excellent in terms of heat resistance, the mechanical properties of a molded product, and feed property. The chopped carbon fiber bundle according to the present invention can be produced in a small number of steps, with high productivity, and in an efficient manner. The method for producing a chopped carbon fiber bundle according to the present invention enables chopped carbon fiber bundles to be produced using an aqueous dispersion of a sizing agent without using a solvent. Therefore, the production method reduces environmental loads and eliminates the need for large-scale equipment. Description of Embodiments

Details of the present invention are described below. The present invention is not limited to the following embodiment. Various modifications may be made within the scope of the summary of the present invention.

In the present specification, in the case where a range is expressed using “to”, it is considered that the range includes the values or physical properties described before and after “to”.

### [Chopped Carbon Fiber Bundle]

A chopped carbon fiber bundle according to an aspect of the present invention is a chopped carbon fiber bundle including carbon fibers and a sizing agent, the sizing agent including a compound having a maleimide group, the compound having a maleimide group being liquid at 25° C.

A chopped carbon fiber bundle according to another aspect of the present invention is a chopped carbon fiber bundle including carbon fibers and a sizing agent, the sizing agent including a compound having a maleimide group, the compound having a maleimide group having an aliphatic hydrocarbon group having 2 or more carbon atoms.

A chopped carbon fiber bundle according to another aspect of the present invention is a chopped carbon fiber bundle including carbon fibers and a sizing agent, the sizing agent including a compound having a maleimide group. The viscosity of the compound having a maleimide group at 25° C. is 100000 mPa·s or less.

A chopped carbon fiber bundle according to another aspect of the present invention is a chopped carbon fiber bundle including carbon fibers and a compound having a maleimide group. The content of the compound having a maleimide group in the chopped carbon fiber bundle is 10% by mass or less.

A carbon fiber bundle is a bundle of carbon fiber single fibers (filaments).

Chopped carbon fiber bundles are pieces produced by cutting a carbon fiber bundle to a predetermined length.

The length of the single fibers included in the chopped carbon fiber bundle is preferably 1 to 50 mm and is more preferably 3 to 30 mm. When the above fiber length falls within the above range, the chopped carbon fiber bundle can be markedly easily melt-kneaded with a thermoplastic resin. The above fiber length is preferably a weighted average fiber length.

When the chopped carbon fiber bundle is composed of single fibers having a length of 1 to 15 mm, the fiber length can be measured by observing the chopped carbon fiber bundle with an optical microscope. When the chopped carbon fiber bundle is composed of single fibers having a length of 15 to 50 mm, the fiber length can be measured with a ruler or vernier calipers.

The number of filaments included in the chopped carbon fiber bundle is commonly about 1000 to 100000. The number of the filaments is preferably 3000 to 60000 in consideration of the carbon fiber-binding property.

The bulk density of the chopped carbon fiber bundle means the weight of the chopped carbon fiber bundles per unit volume. The larger the binding force of the chopped carbon fiber bundles, the lower the bulk density. This is because, when the chopped carbon fiber bundles have a large binding force, the fiber bundles are unlikely to disintegrate into carbon fiber filaments and the frictional resistance that occurs when chopped carbon fiber bundles are brought into contact with one another is reduced accordingly.

When chopped carbon fiber bundles have a large binding force, bridging is unlikely to occur among the chopped carbon fiber bundles. That is, chopped carbon fiber bundles having a large binding force are excellent in terms of feed property and can be fed to an extruder in a consistent manner. In consideration of feed property, the bulk density of the chopped carbon fiber bundle according to the present invention is preferably 200 g/L or more and is more preferably 400 g/L or more. The upper limit for the bulk density of the chopped carbon fiber bundle according to the present invention is not set. Chopped carbon fiber bundles having a bulk density of 600 g/L or less are easy to produce because it becomes unnecessary to reduce gaps present inside the carbon fiber bundles.

The bulk density of the chopped carbon fiber bundle is measured by the following method.

The measurement environment is set such that the temperature is 25° C.±3° C. and the humidity is 50% RH ±20% RH. Into a 2-liter graduated cylinder, 300 g of the chopped carbon fiber bundles are charged. The cylinder is tapped 10 times vertically at a stroke of 5 mm. Subsequently, the volume of the chopped carbon fiber bundles is read. The cylinder is further tapped another 10 times vertically. Subsequently, the volume of the chopped carbon fiber bundles is read. When the volume changes during tapping, the cylinder is again tapped another 10 times vertically and, subsequently, the volume of the chopped carbon fiber bundles is read. The operation of tapping the cylinder 10 times vertically and then reading the volume of the chopped carbon fiber bundles is repeated until the volume of the chopped carbon fiber bundles remains unchanged. When the volume of the chopped carbon fiber bundles remains unchanged, the scale mark of the graduated cylinder at the same height as one of the chopped carbon fiber bundles which is located at the highest position inside the graduated cylinder is read as the volume V (L) of the chopped carbon fiber bundles. On the basis of the above volume and the weight (300 g) of the chopped carbon fiber bundles, the bulk density is calculated using the following formula.

Bulk density=300/V

The content of the sizing agent in the chopped carbon fiber bundle is preferably 0.1% by mass or more, is more preferably 1% by mass or more, and is further preferably 2% by mass or more in consideration of the binding property. In consideration of the dispersibility of carbon fibers in the melt-kneading of a thermoplastic resin and chopped carbon fiber bundles, the content of the sizing agent in the chopped carbon fiber bundle according to the present invention is preferably 10% by mass or less, is more preferably 5% by mass or less, and is further preferably 4% by mass or less. The content of the sizing agent can be measured in accordance with JIS R 7604 (1999). The content of the compound having a maleimide group in the chopped carbon fiber bundle is preferably 10% by mass or less, is more preferably 5% by mass or less, and is further preferably 3% by mass or less in order to achieve both heat resistance and binding property.

The content of carbon fibers in the chopped carbon fiber bundle is preferably 95% by mass or more and is more preferably 96% by mass or more in order to make it easy to disperse the chopped carbon fiber bundles when a thermoplastic resin and the chopped carbon fiber bundles are melt-kneaded. In consideration of binding property, the content of carbon fibers in the chopped carbon fiber bundle according to the present invention is preferably 99% by mass or less and is more preferably 98% by mass or less. The content of carbon fibers is the outcome of subtracting the content (% by mass) of the sizing agent from the amount (100% by mass) of the chopped carbon fiber bundle.

### <Carbon Fibers>

Examples of the carbon fibers included in the chopped carbon fiber bundle according to the present invention include carbon fibers produced from a pitch, rayon, or polyacrylonitrile raw material substance. Among these, a polyacrylonitrile carbon fiber is preferable because it is excellent in terms of productivity and mechanical properties.

The diameter of the carbon fibers (filaments) is preferably 4 to 12 μm and is more preferably 5 to 8 μm. The tensile elastic modulus of the carbon fibers is preferably 230 to 350 GPa in consideration of cost and versatility.

### <Sizing Agent>

The chopped carbon fiber bundle includes a sizing agent including a compound having a maleimide group (hereinafter, the above sizing agent may be referred to as “this sizing agent”). The sizing agent is preferably deposited on the carbon fibers. Since the sizing agent includes the compound having a maleimide group, a chopped carbon fiber bundle having high heat resistance can be produced.

Among compounds having a maleimide group, a compound having a plurality of maleimide groups per molecule is commonly referred to as “maleimide resin” because, even in the case where the compound has a low molecular weight, when the compound is heated, the molecular weight of the compound is increased and the compound becomes resinous. The same applies to “epoxy resin” described below.

### (Compound Having Maleimide Group)

The compound having a maleimide group is preferably liquid at 25° C., that is, the softening or melting temperature of the compound having a maleimide group is preferably less than 25° C., in order to make it easy to dissolve and mix the compound with another resin and enhance dispersibility in water. When the chopped carbon fiber bundle includes a compound having a maleimide group which is liquid at 25° C., even in the case where the chopped carbon fiber bundle is included in a molding material composed of a matrix resin having a high melting temperature, degradation of the mechanical properties of a molded product made of the molding material can be limited because the compound having a maleimide group which is liquid at 25° C. is resistant to decomposition even at high temperatures. Moreover, since the compound having a maleimide group is liquid, the compound is readily miscible with the carbon fiber bundle. This enables the production of a chopped carbon fiber bundle having an excellent binding property.

The compound having a maleimide group is preferably a compound having a plurality of maleimide groups per molecule because, in such a case, a crosslinking reaction occurs at high temperatures to enhance heat resistance.

The viscosity of the compound having a maleimide group at 25° C. is preferably 100000 mPa·s or less. The compound having a maleimide group may be either a low-molecular-weight compound having a molecular weight of 90 to 1000 or a maleimide resin having a viscosity of 1000 to 100000 mPa·s at 25° C. The compound having a maleimide group is preferably a maleimide resin having a viscosity of 1000 to 100000 mPa·s at 25° C. in consideration of heat resistance.

The viscosity can be measured in accordance with “Method for Measuring Viscosity with Cone-Flat Plate Rotational Viscometer” described in JIS Z 8803 (2011).

The compound having a maleimide group preferably includes an aliphatic hydrocarbon group having 2 or more carbon atoms in consideration of dispersibility in water.

The compound having a maleimide group preferably has an aliphatic portion having 5 or more carbon atoms in order to make it easy to dissolve and mix the compound with another resin.

Specific examples of the maleimide resin include aliphatic maleimide resins having an aliphatic portion such as an aliphatic or alicyclic hydrocarbon group having 2 or more carbon atoms, such as an alkylene bismaleimide, triethylene glycol bis(maleimideethylcarbonate), 1,13-bismaleimide-4,7,10-trioxatridecane, and 1,11-bismaleimide-3,6,9-trioxaundecane; aromatic maleimide resins, such as N,N′-m-phenylene bismaleimide, 4,4′-diphenylmethane bismaleimide, 4,4′-diphenyl ether bismaleimide, 4,4′-diphenyl sulfone bismaleimide, 4,4′-diphenyl sulfide bismaleimide, 4-methyl-1,3-phenylene bismaleimide, 1,3-phenylene bismaleimide, 2,2′-bis[4-(4-maleimidephenoxy)phenyl]propane, 1,3-bis(4-maleimidephenoxy)benzene, and 1,3-bis(3-maleimidephenoxy)benzene; and maleimide resins (aliphatic-aromatic maleimide resins) having aliphatic and aromatic portions having 2 or more carbon atoms, such as an aliphatic hydrocarbon group having 2 to 100 carbon atoms or an alicyclic hydrocarbon group having 3 to 100 carbon atoms.

The maleimide resin is preferably the maleimide resin having aliphatic and aromatic portions or the aliphatic maleimide resin (including alicyclic maleimide resin) and is more preferably the aliphatic maleimide resin because they are readily miscible with other resins and have excellent dispersibility in water.

Specific examples of the aliphatic bismaleimide resin include the following alkylene bismaleimides: N,N′-methylene bismaleimide, N,N′-ethylene bismaleimide, N,N′-trimethylene bismaleimide, N,N′-tetramethylene bismaleimide, N,N′-pentamethylene bismaleimide, N,N′-hexamethylene bismaleimide, N,N′-heptamethylene bismaleimide, N,N′-octamethylene bismaleimide, N,N′-decamethylene bismaleimide, N,N′-(2,2,4-trimethylhexamethylene) bismaleimide, and N,N′-(oxydimethylene) bismaleimide.

Examples of the aliphatic bismaleimide resin (including alicyclic maleimide resin) include the compound represented by Formula (m1) below (hereinafter, this compound is referred to also as “compound (m1)”).

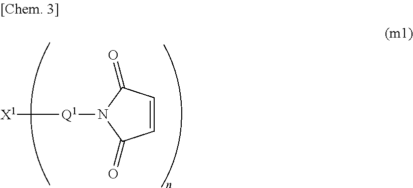

in Formula (m1), X¹ represents a substituted or unsubstituted alicyclic hydrocarbon group having 5 to 8 carbon atoms, Q¹ represents an aliphatic hydrocarbon group having 4 to 50 carbon atoms, and n represents 1 or 2, and

The aliphatic hydrocarbon group represented by Q¹ may be either linear or branched and is preferably linear in consideration of miscibility with other resins. The number of carbon atoms included in the aliphatic hydrocarbon group represented by Q¹ is preferably 5 to 25 and is more preferably 6 to 10 in consideration of miscibility with other resins.

The number of carbon atoms included in the alicyclic hydrocarbon group represented by X¹ is preferably 5 or 6 and is more preferably 6 in consideration of ease of synthesis of the compound.

Examples of the substituent included in the alicyclic hydrocarbon group include a hydrocarbon group having 2 to 50 carbon atoms, a hydroxyl group, a carboxyl group, and an alkoxy group. The substituent is preferably an aliphatic hydrocarbon group having 5 to 25 carbon atoms. The hydrocarbon group that serves as a substituent may contain an unsaturated bond and may be either linear or branched. The hydrocarbon group that serves as a substituent is preferably a linear hydrocarbon group in consideration of miscibility with other resins.

The number of substituents included in the alicyclic hydrocarbon group may be 2 or more and is preferably 0 to 2 in consideration of ease of synthesis of the compound (m1).

The compound (m1) is preferably the compound represented by Formula (m11) below (hereinafter, this compound is referred to also as “compound (m11)”).

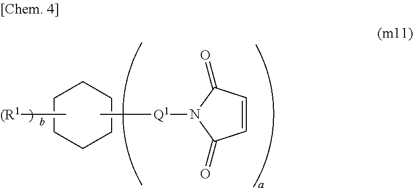

In Formula (m11) above, the cyclohexane ring may contain an unsaturated bond; Q¹ represents the same thing as Q¹ in Formula (m1) above; R¹ represents an aliphatic hydrocarbon group having 2 to 50 carbon atoms; a represents 1 or 2; and b represents an integer of 1 to 4.

The aliphatic hydrocarbon group represented by R¹ may be either linear or branched. The aliphatic hydrocarbon group represented by R¹ is preferably linear. The number of carbon atoms included in the aliphatic hydrocarbon group represented by R¹ is preferably 5 to 25. In the case where the number of R¹'s is 2 or more, a plurality of R¹'s may represent the same group or different groups. a is preferably 2. b is preferably 1 or 2.

Examples of commercial products of the compound (m11) include “BMI-689” produced by Designer Molecules Inc.

The maleimide resin having aliphatic and aromatic portions (aliphatic-aromatic maleimide resin) is preferably the compound represented by Formula (m2) below or the compound represented by Formula (m3) below (hereinafter, this compound is referred to also as “compound (m3)”) and is more preferably the compound (m3).

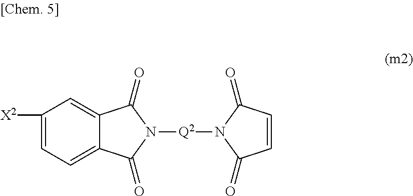

In Formula (m2) above, Q² represents an aliphatic hydrocarbon group (including alicyclic hydrocarbon group) having 6 to 100 carbon atoms; and X² represents an alkyl group having 1 to 12 carbon atoms, an alkenyl group having 3 to 6 carbon atoms, a cycloalkyl group having 5 to 8 carbon atoms, a monovalent aromatic group having 6 to 12 carbon atoms, a benzyl group, a polyoxyalkyl group represented by —(C_{c}H_{2c}O)_{d}—(CₑH₂ₑO)_{f}—C_{g}H_{2g+1} (where c, e, and g each independently represent an integer of 2 to 6, d represents 0 or 1, and f represents an integer of 1 to 30), a group represented by—O—C₆H₄-Q⁵-C₆H₅ (where Q⁵ represents —CH₂—, —C(CH₃)₂—, —CO—, —O—, —S—, or —SO₂—), or a group formed as a result of 1 to 3 hydrogen atoms included in any of the above groups being replaced with a hydroxyl group.

The aliphatic hydrocarbon group (including alicyclic hydrocarbon group) represented by Q² is preferably the aliphatic hydrocarbon group represented by Formula (x1) below.

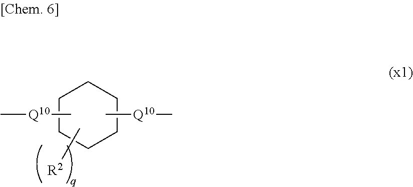

In Formula (x1) above, the cyclohexane ring may contain an unsaturated bond; examples of Q¹⁰ are the same as those of the aliphatic hydrocarbon group represented by Q¹ in Formula (m1) above, and the same applies to a preferable aspect; examples of R² are the same as those of the aliphatic hydrocarbon group represented by R¹ in Formula (m11) above, and the same applies to a preferable aspect; and q represents an integer of 1 to 3.

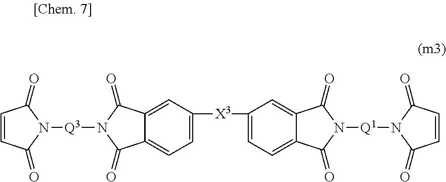

in Formula (m3), Q³ and Q⁴ each independently represent an aliphatic hydrocarbon group (including alicyclic hydrocarbon group) having 6 to 100 carbon atoms, and X³ represents an alkylene group having 2 to 20 carbon atoms, a cycloalkylene group having 5 to 8 carbon atoms, a polyoxyalkylene group represented by —(C_{q}H_{2q}O)ₜ—(CᵣH₂rO)ᵤ—CₛH₂ₛ— (where q, r, and s each independently represent an integer of 2 to 6, t represents 0 or 1, and u represents an integer of 1 to 30), a divalent aromatic group having 6 to 12 carbon atoms, a group represented by —O—C₆H₄-Q⁶-C₆H₄—O— (where Q⁶ represents —CH₂—, —C(CH₃)₂—, —CO—, —O—, —S—, or —SO₂—), or a group formed as a result of 1 to 3 hydrogen atoms included in any of the above groups being replaced with a hydroxyl group.

Examples of the aliphatic hydrocarbon groups represented by Q³ and Q⁴ are the same as those of the aliphatic hydrocarbon group (including alicyclic hydrocarbon group) represented by Q², and the same applies to a preferable aspect. X³ is preferably a group represented by —O—C₆H₄-Q⁶-C₆H₄—O— and is particularly preferably a group represented by —O—C₆H₄-C (CH₃)₂—C₆H₄—O—.

Examples of commercial products of the maleimide resin having aliphatic and aromatic portions include “BMI-1400”, “BMI-1500”, and “BMI-1700” produced by Designer Molecules Inc.

The number of types of the compounds having a maleimide group which are included in this sizing agent may be one. Alternatively, this sizing agent may include two or more types of compounds having a maleimide group which have different structures, molecular weights, or viscosities.

### (Other Component)

This sizing agent may include a component other than the compound having a maleimide group. Examples of the other component include an epoxy resin, a polyester resin, a phenolic resin, a polyamide resin, a polyurethane resin, a polycarbonate resin, a silane coupling agent, an antistatic agent, a lubricant, a smoothing agent, and a surfactant. The number of the other components included in this sizing agent may be either one or two or more.

As the other component, this sizing agent preferably includes, in addition to the compound having a maleimide group, a compound having an epoxy group which does not have a maleimide group (hereinafter, this compound may be referred to simply as “compound having an epoxy group”). When the sizing agent includes the compound having an epoxy group, the mechanical properties of a molded product produced using the chopped carbon fiber bundle according to the present invention can be enhanced.

Examples of the compound having an epoxy group include an epoxy resin. Examples of the epoxy resin include, but are not limited to, a bisphenol-A-type epoxy resin, a bisphenol-F-type epoxy resin, a bisphenol-S-type epoxy resin, a phenol novolac-type epoxy resin, a cresol novolac-type epoxy resin, a biphenyl-type epoxy resin, a naphthalene skeleton-type epoxy resin, an aliphatic epoxy resin, a dicyclopentadiene-type epoxy resin, a glycidyl amine-type epoxy resin, and DPP novolac-type epoxy resin.

In consideration of the heat resistance and feed property of the chopped carbon fiber bundle, the epoxy resin is preferably an epoxy resin that is solid at 25° C., is more preferably an epoxy resin having a melting temperature (in the case where the epoxy resin does not have a melting temperature, softening temperature) of 50° C. or more, and is further preferably an epoxy resin having a melting temperature (in the case where the epoxy resin does not have a melting temperature, softening temperature) of 70° C. or more.

The number of types of the epoxy resins included in this sizing agent may be either one or two or more.

The combination of the compound having a maleimide group and the compound having an epoxy group which are included in this sizing agent is preferably a combination of a maleimide resin that is liquid at 25° C. and an epoxy resin and is particularly preferably a combination of a maleimide resin that is liquid at 25° C. and an epoxy resin that is solid at 25° C. in consideration of miscibility.

As the other component, this sizing agent preferably includes, in addition to the compound having a maleimide group, a surfactant that does not have a maleimide group. When the sizing agent includes the surfactant, an aqueous dispersion of this sizing agent can be readily prepared and, consequently, the environmental load placed when this sizing agent is deposited on the carbon fiber bundles can be reduced.

The surfactant may be any surfactant that enables the compound having a maleimide group to be dispersed in water. Examples thereof include a nonionic surfactant and an anionic surfactant.

Examples of the nonionic surfactant include an aliphatic nonionic surfactant, a phenolic nonionic surfactant, and a Pluronic-type surfactant.

Examples of the aliphatic nonionic surfactant include a higher alcohol ethylene oxide adduct, a fatty acid ethylene oxide adduct, a polyhydric alcohol fatty acid ester ethylene oxide adduct, a fatty acid ester of glycerol, fatty acid esters of sorbitol and sorbitan, and a fatty acid ester of pentaerythritol.

Examples of the phenolic nonionic surfactant include an alkyl phenolic nonionic surfactant and a polycyclic phenolic nonionic surfactant.

Examples of the Pluronic-type surfactant include a polyoxyethylene polyoxypropylene polymer (ethylene oxide and propylene oxide may be any of random, block, and reverse).

Examples of the anionic surfactant include carboxylic acid salts, such as an aliphatic carboxylic acid salt and a polyoxyethylene alkyl ether carboxylic acid salt; sulfuric acid ester salts, such as an alkylbenzene polyethylene glycol ether sulfuric acid ester salt and a polycyclic phenyl ether polyethylene glycol ether sulfuric acid ester salt; and phosphoric acid salts, such as polyoxyethylene alkyl ether phosphoric acid salt and a polyoxyethylene alkyl phenyl ether phosphoric acid ester salt. Examples of the countercation include an ammonium ion.

The surfactant may be a commercial product.

Examples of commercial products of the nonionic surfactant include “Newcol 707”, “Newcol 723”, and “Newcol 707-F” produced by Nippon Nyukazai Co., Ltd. and “ADEKA Pluronic F-88” produced by ADEKA Corporation.

Examples of the anionic surfactant include “Newcol 707-SF” and “Newcol 723-SF” produced by Nippon Nyukazai Co., Ltd. and “HITENOL NF-13” and “HITENOL NF-17” produced by DKS Co. Ltd.

The number of types of the surfactants included in this sizing agent may be either one or two or more.

### (Contents of Components)

The content of the compound having a maleimide group in this sizing agent is preferably 10% to 90% by mass, is more preferably 20% to 80% by mass, and is further preferably 30% to 70% by mass of the total mass of this sizing agent. When the content of the compound having a maleimide group is equal to or more than the above lower limit, heat resistance can be enhanced. When the content of the compound having a maleimide group is equal to or less than the above upper limit, dispersibility in water can be enhanced.

In the case where this sizing agent includes the compound having an epoxy group, the content of the compound is preferably 10% to 80% by mass, is more preferably 30% to 70% by mass, and is further preferably 40% to 60% by mass of the total mass of the sizing agent. When the content of the compound having an epoxy group is equal to or more than the above lower limit, the mechanical properties of the resulting molded product can be enhanced. When the content of the compound having an epoxy group is equal to or less than the above upper limit, heat resistance can be enhanced.

In the case where this sizing agent includes the surfactant that does not have a maleimide group, the content of the surfactant is preferably 1% to 30% by mass, is more preferably 5% to 20% by mass, and is further preferably 10% to 15% by mass of the total mass of this sizing agent. When the content of the surfactant is equal to or more than the above lower limit, dispersibility in water can be enhanced. When the content of the surfactant is equal to or less than the above upper limit, heat resistance can be enhanced.

### [Method for Producing Chopped Carbon Fiber Bundle]

The chopped carbon fiber bundle can be produced by applying an aqueous dispersion of the sizing agent including the compound having a maleimide group to carbon fibers or a carbon fiber bundle and performing drying to cause the sizing agent to be deposited on the carbon fiber bundle.

The chopped carbon fiber bundle produced by the above production method is, for example, mixed with a thermoplastic resin and the resulting mixture can be used as a fiber-reinforced composite material in molding methods, such as injection molding.

The number of times the sizing agent is deposited on the carbon fiber bundle is not limited to one and may be two or more. For example, the sizing agent can be deposited on the carbon fiber bundle by coiling a carbon fiber bundle on which a primary sizing agent has been deposited around a bobbin to form a roll, unwinding the carbon fiber bundle from the roll, and subsequently applying an aqueous dispersion of a secondary sizing agent to the carbon fiber bundle. The compositions of the primary and secondary sizing agents may be different from or identical to each other.

The solid component concentration in the aqueous dispersion of this sizing agent is not limited and may be selected in accordance with the stability required by an aqueous dispersion and the viscosity easy to handle. The solid component concentration in the aqueous dispersion of this sizing agent is preferably 1% to 50% by mass, is more preferably 3% to 45% by mass, and is further preferably 5% to 40% by mass. When the solid component concentration in the aqueous dispersion of this sizing agent is equal to or more than the above lower limit, the transportation costs can be reduced. When the solid component concentration in the aqueous dispersion of this sizing agent is equal to or less than the above upper limit, it becomes markedly easy to handle the aqueous dispersion of this sizing agent.

When the sizing agent is applied to the carbon fiber bundle, in order to adjust the amount of the sizing agent deposited, an adequate amount of water may be added to the aqueous dispersion such that the solid component concentration is further reduced to about 1% to 20% by mass.

Since an aqueous sizing agent is used in the method for producing the chopped carbon fiber bundle, the environmental load can be reduced compared with a sizing agent that includes an organic solvent.

Specific examples of the method for producing the chopped carbon fiber bundle include a method including the steps (1) to (3) below.

(1) Step of applying an aqueous dispersion of the sizing agent to prepare a long-length carbon fiber bundle on which the sizing agent is deposited

(2) Step of cutting the carbon fiber bundle into pieces

(3) Step of drying the carbon fiber bundle to which the aqueous dispersion of the sizing agent has been applied

In the step (1), for example, an aqueous dispersion of the sizing agent is applied to a long-length carbon fiber bundle rewound from a roll.

The method with which an aqueous dispersion of the sizing agent is applied to a long-length carbon fiber bundle is not limited. Examples thereof include a touch-roller method, in which a roller is partially immersed in the aqueous dispersion of the sizing agent in order to apply the aqueous dispersion of the sizing agent onto the surface of the roller and the roller is subsequently brought into contact with the carbon fiber bundle in order to apply the sizing agent to the carbon fiber bundle. Alternatively, an immersion method, in which the carbon fiber bundle is immersed in an aqueous dispersion of the sizing agent, may also be used.

In the step (2), the carbon fiber bundle is cut into pieces.

The method with which the carbon fiber bundle is cut into pieces is not limited. Examples thereof include a method in which a rotary cutter, a guillotine cutter, a roving cutter, or the like is used.

The length of pieces into which the carbon fiber bundle is cut is preferably set to 1 to 50 mm and is more preferably set to 3 to 30 mm. When the length of pieces into which the carbon fiber bundle is cut falls within the above range, it becomes easy to melt-knead the resulting chopped carbon fiber bundles with a thermoplastic resin.

In the step (3), the carbon fiber bundle to which an aqueous dispersion of the sizing agent has been applied is dried.

Examples of the drying method include methods using publicly known heating apparatuses, such as a hot-air dryer, a panel heater dryer, a muffle furnace, and a heating roller. In another case, the carbon fiber bundle to which the aqueous dispersion of the sizing agent has been applied may be air-dried without performing heating. In the case where drying is performed by heating, the heating temperature is preferably about 100° C. to 200° C.

The steps (1) to (3) may be conducted in either a continuous or batch process.

The order in which the steps (1) to (3) are conducted is not limited; these steps may be conducted in the order of (1) , (2) , and (3) or the order of (1) , (3) , and (2).

In the case where these steps are conducted in the order of (1), (2), and (3), in order to prevent the chopped strands from being bonded to one another, in the step (3), it is preferable to perform drying while transporting the chopped strands under vibrating conditions. The method in which the above steps are conducted in the order of (1), (3), and (2) is advantageous in that a heating apparatus having a relatively simple structure can be used in the step (2).

The amount of the sizing agent deposited on the chopped carbon fiber bundle can be set appropriately. The amount of the sizing agent deposited on the chopped carbon fiber bundle is preferably 0.1% to 10% by mass, is more preferably 1% to 5% by mass, and is further preferably 2% to 4% by mass of the total mass of the sizing agent and the carbon fiber bundle. When the amount of the sizing agent deposited is equal to or more than the above lower limit, the chopped carbon fiber bundle has an excellent binding property. When the amount of the sizing agent deposited is equal to or less than the above upper limit, the chopped strands can be readily dispersed after cutting.

The amount of the sizing agent deposited can be controlled by, for example, adjusting the solid component concentration in the aqueous dispersion of the sizing agent, which is used in the step (1), or adjusting the pressing force (amount of squeeze) at which the carbon fiber bundle is brought into contact with the roller.

It is preferable to produce the chopped carbon fiber bundle by applying an aqueous dispersion of a secondary sizing agent including a compound having a maleimide group to a long-length carbon fiber bundle on which a primary sizing agent has been deposited in order to prepare a long-length carbon fiber bundle that further includes the aqueous dispersion of the secondary sizing agent and cutting the carbon fiber bundle including the aqueous dispersion of the secondary sizing agent into pieces. In such a case, it becomes easy to cut the carbon fiber bundle into pieces.

The primary sizing agent used in the above method is preferably a sizing agent including a compound having an epoxy group and is particularly preferably a sizing agent that includes a compound having an epoxy group and does not include a compound having a maleimide group. The solid and liquid component concentration in an aqueous dispersion of the primary sizing agent (which may include a component other than the compound having an epoxy group, such as a surfactant) which is used for the deposition of the primary sizing agent is preferably 0.1% to 50% by mass, is preferably 0.5% to 30% by mass, and is further preferably 1% to 20% by mass.

The steps (1) and (3) are conducted using the aqueous dispersion of the primary sizing agent to prepare a long-length carbon fiber bundle on which the primary sizing agent has been deposited.

The amount of the primary sizing agent deposited is preferably 0.05% to 2% by mass, is more preferably 0.1% to 1.5% by mass, and is further preferably 0.2% to 1.4% by mass of the total mass of the primary sizing agent and the carbon fiber bundle.

Subsequently, an aqueous dispersion of the secondary sizing agent that includes a compound having a maleimide group is applied to the carbon fiber bundle on which the primary sizing agent has been deposited in order to prepare a chopped carbon fiber bundle through the steps (1) to (3).

The secondary sizing agent includes a compound having a maleimide group and does not necessarily include a compound having an epoxy group. The secondary sizing agent may include both compound having a maleimide group and compound having an epoxy group. The secondary sizing agent preferably includes both compound having a maleimide group and compound having an epoxy group in consideration of heat resistance.

The solid component concentration in an aqueous dispersion of the secondary sizing agent (which may include another component, such as a surfactant) which is used for the deposition of the secondary sizing agent is preferably 1% to 50% by mass, is preferably 3% to 45% by mass, and is further preferably 5% to 40% by mass.

In the case where the secondary sizing agent includes both compound having a maleimide group and compound having an epoxy group, the content of the compound having a maleimide group is preferably 10% to 80% by mass and is particularly preferably 20% to 60% by mass, and the content of the compound having an epoxy group is preferably 10% to 80% by mass and is particularly preferably 30% to 70% by mass, with the solid content being 100% by mass, in order to achieve both heat resistance and binding property.

The amount of the secondary sizing agent deposited is preferably set such that the proportion of the total amount of the sizing agent deposited on the carbon fiber bundle to the total mass of the sizing agent and the carbon fiber bundle falls within the above-described preferable range.

### [Applications]

The chopped carbon fiber bundle can be used as a reinforcement material for matrix resins composed of various thermoplastic or thermosetting resins.

For example, pellets composed of the chopped carbon fiber bundles and the matrix resin can be produced. A molded article can be produced using the pellets.

As a matrix resin, for example, publicly known thermoplastic or thermosetting resins can be used. Examples of the thermoplastic resins include a polycarbonate resin, a nylon resin, a polyester resin, an ABS resin, a polystyrene resin, a polyphenylene ether resin, a polyoxyethylene resin, a polyolefin resin, a polyether imide resin, other super engineering plastics that are industrially useful, and polymer alloy resins thereof. Examples of the thermosetting resins include an unsaturated polyester resin, a vinyl ester resin, and a phenolic resin.

Since the chopped carbon fiber bundle according to the above-described aspect has excellent heat resistance, it can be advantageously used as a reinforcement material for super engineering plastics, which require a high melt-kneading temperature.

The method with which a carbon fiber-reinforced resin composition including the chopped carbon fiber bundles is molded is not limited, and publicly known methods can be used. Commonly, in the case where the matrix resin is a thermoplastic resin, injecting molding is employed. In the case where the matrix resin is a thermosetting resin, press molding, or high-pressure compression molding using a sheet molding compound or bulk molding compound is employed.

### EXAMPLES

The present invention is described further specifically with reference to Examples below. The present invention is not limited by the description below.

### [Raw Materials for Sizing Agent]

Table 1 lists the raw materials used for preparing sizing agents in Examples and Comparative Examples below.

TABLE 1

| Category | Product name | Substance | Available from |
|---|---|---|---|
| Compound having | BMI-689 | Bismaleimide resin that is liquid at 25° C. | Designer Molecules Inc. |
| maleimide group | BMI-1700 | Bismaleimide resin that is liquid at 25° C. | Designer Molecules Inc. |
| | BMI-2300 | Bismaleimide resin that is solid at 25° C. | Daiwa Kasei Industry |
| | | | Co., Ltd. |
| Compound having | jER1004 | Bisphenol-A-type epoxy resin that is solid | Mitsubishi Chemical |
| epoxy group | | at 25° C. | Corporation |
| | jER1001 | Bisphenol-A-type epoxy resin that is solid | Mitsubishi Chemical |
| | | at 25° C. | Corporation |
| | jER828 | Bisphenol-A-type epoxy resin that is liquid | Mitsubishi Chemical |
| | | at 25° C. | Corporation |
| Surfactant | ADEKA | Polyoxyethylene-polyoxypropylene condensate | ADEKA Corporation |
| | Pluronic F-88 | (nonionic surfactant) | |
| | HITENOL | Polyoxyethylene polycyclic phenyl ether | DKS Co. Ltd. |
| | NF-17 | ammonium sulfate (anionic surfactant) | |

The molecular weight, viscosity, and structural formula of each of the compounds having a maleimide group which were used in Examples are described below.

### <BM1-689>

Molecular weight: 689

Viscosity at 25° C.: 1500 mPa·s

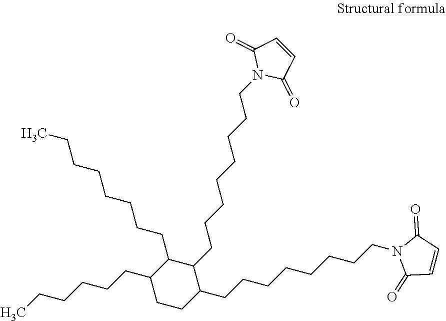 [SMILES: CCCCCCCCC1C(CCCCCC)CCC(CCCCCCCCN2C(=O)C=CC2=O)C1CCCCCCCCN1C(=O)C=CC1=O]

(The aliphatic skeleton contains unsaturated bond in molecule)

### <BMI-1700>

Molecular weight: 1715

Viscosity at 25° C.: 37500 mPa·s

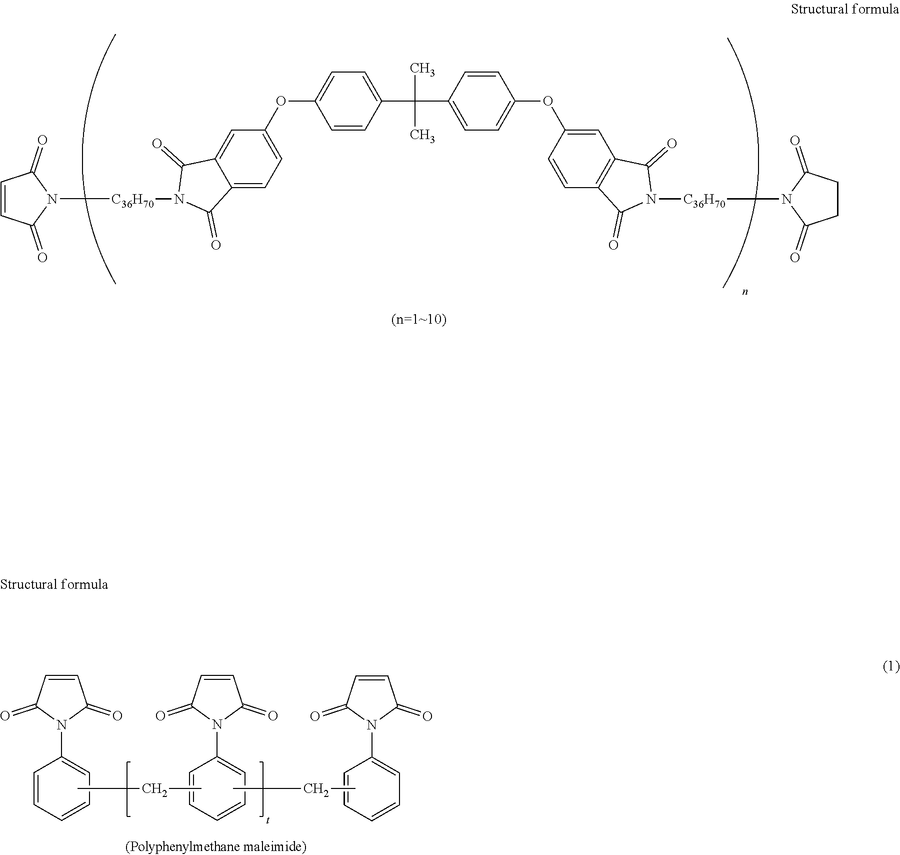

### [Measurement and Evaluation Methods]

### (Measurement of Bulk Density)

In accordance with the method for measuring bulk density which is described above, 300 g of chopped carbon fiber bundles were charged in a 2-liter graduated cylinder. While an impact was given to the graduated cylinder, the volume of the chopped carbon fiber bundles at which the volume remained unchanged was measured. The bulk density of the chopped carbon fiber bundles was calculated on the basis of the above volume and the weight of the chopped carbon fiber bundles.

### (Evaluation of Feed Property)

Into a gravimetric screw feeder including a screw having a diameter of 30 mm, 1 kg of the chopped carbon fiber bundles were charged through a hopper. While the chopped carbon fiber bundles were transported at a rate of 15 kg per hour, the feed property was determined in accordance with the following criteria.

◯: The whole amount (1 kg) of chopped carbon fiber bundles could be transported.

Δ: The whole amount (1 kg) of chopped carbon fiber bundles could be transported, although bridging of the chopped carbon fiber bundles at the hopper was observed.

×: Transportation failure occurred since bridging of the chopped carbon fiber bundles occurred during transportation

### (Measurement of Heating Loss in Weight of Sizing Agent)

The sizing agent was subjected to a thermogravimetric analyzer Q500 (produced by TA Instruments) under the following conditions to determine a thermogravimetric curve.

Atmosphere: in nitrogen

Heating rate: 20 ° C/min

Temperature range: 30° C. to 500° C.

The mass W100 of the sizing agent at 100° C. and the mass W400 of the sizing agent at 400° C. were determined from the thermogravimetric curve. The heating loss ratio Q(%) was calculated using the following formula.

Q={(W100-W400)/W100}×100

The sizing agent used in the measurement of heating loss was a sample prepared by heating the aqueous dispersion of the secondary sizing agent prepared in each of Examples below at 110° C. for 1 hour to remove moisture. In the case where a solution of the secondary sizing agent was used, a sample prepared by performing vacuum drying at 130° C. for 1 hour to remove the solvent was used in the measurement of heating loss.

### (Evaluation of Emulsifying Property)

An evaluation of “◯” was given when an aqueous dispersion of the secondary sizing agent could be prepared by phase inversion emulsification in the preparation of the aqueous dispersion in each of Examples below. An evaluation of “×” was given when the aqueous dispersion could not be prepared by phase inversion emulsification.

### Production Example 1

### (Preparation of Carbon Fiber Bundle on Which Primary Sizing Agent Was Deposited)

Using a homomixer, jER1001 (40 parts by mass), jER828 (40 parts by mass), ADEKA Pluronic F-88 (20 parts by mass) were stirred to form a uniform mixture while being heated at 110° C. Hereby, a primary sizing agent was prepared. While the primary sizing agent was stirred with the homomixer, ion-exchange water was added dropwise to the primary sizing agent at a rate of 20 mL per minute. After the phase inversion point had been passed, the amount of water added was increased to 100 mL per minute. Hereby, an aqueous dispersion of the primary sizing agent was prepared. The amount of the ion-exchange water added to the sizing agent was adjusted such that the concentration of the sizing agent in the dispersion liquid of the sizing agent was 30% by mass.

A long-length polyacrylonitrile carbon fiber bundle (produced by Mitsubishi Chemical Corporation, product name: PYROFIL (registered trademark) TR50S15L, number of filaments: 15000, tensile elastic modulus: 240 GPa) on which a sizing agent was not deposited was immersed in an aqueous dispersion in which the concentration of the solid component of the primary sizing agent was adjusted to 1.5% by mass and then passed through a nip roller. Subsequently, the carbon fiber bundle was brought into contact with a heating roller having a surface temperature of 140° C. for 10 seconds in order to perform drying. Hereby, a carbon fiber bundle on which the primary sizing agent had been deposited was prepared. The amount of squeezing performed by the nip roller was adjusted such that the amount of the primary sizing agent deposited was 0.2% by mass of the total mass of the primary sizing agent and the carbon fiber bundle.

### Example 1

### (Preparation of Aqueous Dispersion of Secondary Sizing Agent)

The raw materials listed in Table 1 were mixed with one another in the amounts (parts by mass) described in the column “Example 1” of Table 2. To the resulting mixture, 15 parts by mass of HITENOL NF-17, which is an anionic surfactant, was added. Then, stirring was performed to form a uniform mixture while heating was performed at 110° C. Hereby, a secondary sizing agent was prepared.

While the secondary sizing agent was stirred, ion-exchange water was added to the secondary sizing agent and phase inversion emulsification was performed using a homomixer. While the secondary sizing agent was stirred with the homomixer, ion-exchange water was added dropwise to the secondary sizing agent at a rate of 20 mL per minute. After the phase inversion point had been passed, the amount of water added was increased to 100 mL per minute. Hereby, a dispersion liquid of the sizing agent, which was an aqueous dispersion of the secondary sizing agent, was prepared. The amount of the ion-exchange water added to the secondary sizing agent was adjusted such that the concentration of the secondary sizing agent in the dispersion liquid of the secondary sizing agent was 30% by mass.

### (Preparation of Chopped Carbon Fiber Bundle)

The carbon fiber bundle on which the primary sizing agent had been deposited was immersed in the aqueous dispersion of the secondary sizing agent, which was prepared in the above-described manner. After the carbon fiber bundle had been passed through a nip roller, the carbon fiber bundle was cut into pieces having a length of 6 mm with a roving cutter while the carbon fiber bundle was wet. The pieces of the carbon fiber bundle were dried in a hot-air drying furnace at 130° C. Hereby, chopped carbon fiber bundles were prepared. The concentration of the aqueous dispersion of the secondary sizing agent and the amount of squeezing performed by the nip roller were adjusted such that the total amount of the sizing agents deposited, that is, the total amount of the primary and secondary sizing agents deposited, was 3% by mass of the total mass of the sizing agents and the carbon fiber bundle.

Table 2 lists the results of evaluations of the secondary sizing agent and the chopped carbon fiber bundles.

### Examples 2 to 5 and Comparative Example 1

An aqueous dispersion of the secondary sizing agent and chopped carbon fiber bundles were prepared as in Example 1, except that the raw materials listed in Table 1 were mixed with one another in the amounts (parts by mass) described in Table 2 to prepare a secondary sizing agent.

Table 2 lists the results of evaluations of the secondary sizing agent and the chopped carbon fiber bundles.

### Reference Example 1

### (Preparation of Aqueous Dispersion of Secondary Sizing Agent)

The raw materials listed in Table 1 were mixed with one another in the amounts (parts by mass) described in the column “Reference Example 1” of Table 2. To the resulting mixture, 15 parts by mass of HITENOL NF-17, which is a surfactant, was added. Then, stirring was performed while heating was performed at 110° C. Hereby, a secondary sizing agent was prepared. However, the resins and surfactant used as raw materials could not be mixed with one another.

While the secondary sizing agent was stirred with a homomixer, ion-exchange water was added dropwise to the secondary sizing agent at a rate of 20 mL per minute. However, the phase inversion point was not passed, and an aqueous dispersion could not be formed since the water and resin phases were separated from each other.

Since an aqueous dispersion could not be prepared, a solution of the secondary sizing agent was prepared in the following manner.

### (Preparation of Solution of Secondary Sizing Agent)

The raw materials listed in Table 1 were mixed with one another in the amounts (parts by mass) described in the column “Reference Example 1” of Table 2 to prepare a secondary sizing agent. N-methyl-2-pyrrolidone was added to the secondary sizing agent to form a solution. Hereby, a solution of the secondary sizing agent was prepared. The amount of the N-methyl-2-pyrrolidone added to the secondary sizing agent was adjusted such that the concentration of the secondary sizing agent in the solution of the secondary sizing agent was 50% by mass.

### (Preparation of Chopped Carbon Fiber Bundle)

The carbon fiber bundle on which the primary sizing agent had been deposited was immersed in the solution of the secondary sizing agent, which was prepared in the above-described manner. After the carbon fiber bundle had been passed through a nip roller, the carbon fiber bundle was cut into pieces having a length of 6 mm with a roving cutter while the carbon fiber bundle was wet. The pieces of the carbon fiber bundle were dried in a hot-air drying furnace at 180° C. Hereby, chopped carbon fiber bundles were prepared. The concentration of the solution of the secondary sizing agent and the amount of squeezing performed by the nip roller were adjusted such that the total amount of the sizing agents deposited, that is, the total amount of the primary and secondary sizing agents deposited, was 3% by mass of the total mass of the sizing agents and the carbon fiber bundle.

Table 2 lists the results of evaluations of the secondary sizing agent and the chopped carbon fiber bundles.

TABLE 2

| | | | | | | | | Reference | Comparative |
|---|---|---|---|---|---|---|---|---|---|
| | | | Example 1 | Example 2 | Example 3 | Example 4 | Example 5 | Example 1 | Example 1 |
| Secondary | Maleimide | BMI-689 | 15 | 30 | 45 | 65 | | | |
| sizing agent | resin | BMI-1700 | | | | | 30 | | |
| (mass part) | | BMI-2300 | | | | | | 30 | |
| | Epoxy | jER1004 | 70 | 55 | 40 | 20 | 55 | 55 | 50 |
| | resin | jER828 | | | | | | | 35 |

| | | | | | | | |
|---|---|---|---|---|---|---|---|
| Heating loss ratio of secondary | 11.1 | 10.8 | 10.5 | 10.2 | 10.6 | 4.1 | 39.5 |
| sizing agent, Q (%) | | | | | | | |
| Bulk density of chopped carbon | 560 | 520 | 470 | 350 | 550 | 510 | 450 |
| fiber bundle (g/L) | | | | | | | |
| Emulsifying property | ◯ | ◯ | ◯ | ◯ | ◯ | X | ◯ |
| Feed property | ◯ | ◯ | ◯ | Δ | ◯ | ◯ | ◯ |

In any of Examples 1 to 5, the heating loss ratio Q of the sizing agent was low. Thus, it is considered that the chopped carbon fiber bundle had excellent heat resistance. In Examples 1 to 3 and 5, suitable results were obtained also in terms of feed property. In Reference Example 1, the emulsifying property was poor, although the heat resistance and feed property were good.

In Comparative Example 1, the heating loss ratio of the sizing agent was high. Thus, it is considered that heat resistance was poor.

Although the present invention has been described in detail with reference to specific aspects, it is apparent to a person skilled in the art that various alterations and modifications can be made therein without departing from the spirit and scope of the present invention.

1. A carbon fiber bundle comprising:
a bundle of single carbon fibers; and
a sizing agent comprising a compound having a maleimide group that is liquid at 25° C.,
wherein
a length of single carbon fibers is 1 to 50 mm.

2. A carbon fiber bundle comprising:
a bundle of single carbon fibers; and
a sizing agent comprising a compound having a maleimide group and an aliphatic hydrocarbon group having 2 or more carbon atoms,
wherein
a length of the single carbon fibers included is 1 to 50 mm.

3. The carbon fiber bundle according to claim 1, wherein a viscosity of the compound having a maleimide group is 100,000 mPa·s or less at 25° C.

4. The carbon fiber bundle according to claim 2, wherein a viscosity of the compound having a maleimide group is 100,000 mPa·s or less at 25° C.

5. The carbon fiber bundle according to claim 1, wherein the compound having a maleimide group is a compound represented by Formula m1 or m3 below, 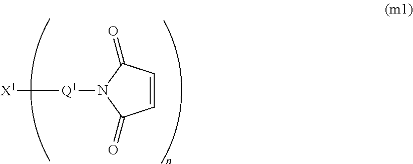
wherein in Formula (m1), X¹ represents a substituted or unsubstituted alicyclic hydrocarbon group having 5 to 8 carbon atoms, Q¹ represents an aliphatic hydrocarbon group having 4 to 50 carbon atoms, and n represents 1 or 2, and 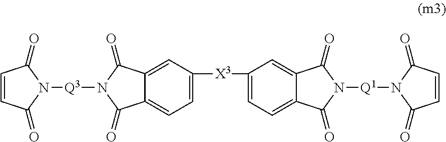
wherein in Formula (m3), Q³ and Q⁴ each independently represent an aliphatic hydrocarbon group having 6 to 100 carbon atoms, and X³ represents an alkylene group having 2 to 20 carbon atoms, a cycloalkylene group having 5 to 8 carbon atoms, a polyoxyalkylene group represented by —(C_{q}H_{2q}O)ₜ—(CᵣH₂ᵣO)ᵤ—CₛH₂ₛ— wherein q, r, and s each independently represent an integer of 2 to 6, t represents 0 or 1, and u represents an integer of 1 to 30, a divalent aromatic group having 6 to 12 carbon atoms, a group represented by—O—C₆H₄-Q⁶-C₆H₄—O— wherein Q⁶ represents —CH₂—, —C(CH₃)₂—, —CO—, —O—, —S—, or —SO₂—, or a group formed as a result of 1 to 3 hydrogen atoms included in any of the above groups being replaced with a hydroxyl group.

6. The carbon fiber bundle according to claim 2, wherein the compound having a maleimide group is a compound represented by Formula m1 or m3 below, 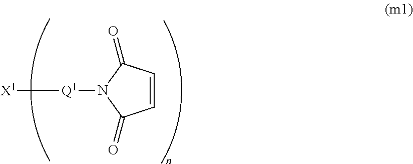
wherein in Formula (m1), X¹ represents a substituted or unsubstituted alicyclic hydrocarbon group having 5 to 8 carbon atoms, Q¹ represents an aliphatic hydrocarbon group having 4 to 50 carbon atoms, and n represents 1 or 2, and 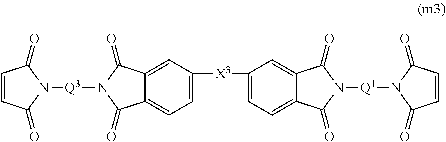
wherein in Formula (m3), Q³ and Q⁴ each independently represent an aliphatic hydrocarbon group having 6 to 100 carbon atoms, and X³ represents an alkylene group having 2 to 20 carbon atoms, a cycloalkylene group having 5 to 8 carbon atoms, a polyoxyalkylene group represented by —(C_{q}H_{2q}O)ₜ—(CᵣH₂ᵣO)ᵤ—CₛH₂ₛ— wherein q, r, and s each independently represent an integer of 2 to 6, t represents 0 or 1, and u represents an integer of 1 to 30, a divalent aromatic group having 6 to 12 carbon atoms, a group represented by—O—C₆H₄-Q⁶-C₆H₄—O— wherein Q⁶ represents —CH₂—, —C(CH₃)₂—, —CO—, —O—, —S—, or —SO₂—, or a group formed as a result of 1 to 3 hydrogen atoms included in any of the above groups being replaced with a hydroxyl group.

7. The carbon fiber bundle according to claim 1, which has a bulk density of 200 g/L or more.

8. The carbon fiber bundle according to claim 2, which has a bulk density of 200 g/L or more.

9. The carbon fiber bundle according to claim 1, which has a bulk density of 600 g/L or less.

10. The carbon fiber bundle according to claim 2, which has a bulk density of 600 g/L or less.

11. The carbon fiber bundle according to claim 1, wherein the compound having a maleimide group has an aliphatic group having 5 or more carbon atoms.

12. The carbon fiber bundle according to claim 2, wherein the compound having a maleimide group has an aliphatic group having 5 or more carbon atoms.

13. A carbon fiber bundle comprising:
a bundle of single carbon fibers; and
a sizing agent comprising a compound having a maleimide group with a viscosity of 100,000 mPa·s or less at 25° C.,
wherein
a length of the single carbon fibers is 1 to 50 mm.

14. The carbon fiber bundle according to claim 13, which has a bulk density of 200 g/L or more.

15. The carbon fiber bundle according to claim 13, wherein the compound having a maleimide group has an aliphatic group having 5 or more carbon atoms.

16. A carbon fiber bundle comprising:
a bundle of single carbon fibers; and
greater than zero to 10% by mass of a compound having a maleimide group and an aliphatic hydrocarbon group having 2 or more carbon atoms,
wherein
a length of the single carbon fibers is 1 to 50 mm.

17. The carbon fiber bundle according to claim 16, which has a bulk density of 200 g/L or more.

18. The carbon fiber bundle according to claim 16, wherein the compound having a maleimide group has an aliphatic group having 5 or more carbon atoms.

19. A pellet comprising:
the carbon fiber bundle according to claim 1; and
a matrix resin.

20. A pellet comprising:
the carbon fiber bundle according to claim 2; and
a matrix resin.
